(19) United States
(12) Patent Application Publication
(10) Pub. No.: US 2016/0356942 A1
(43) Pub. Date: Dec. 8, 2016

(54) LIGHT EMITTING DIODE LIGHT PANELS

(71) Applicant: CORNING INCORPORATED, Corning, NY (US)

(72) Inventors: Sarko Cherekdjian, Campbell, CA (US); Charles Mitchel Sorensen, JR., Haverstraw, NY (US)

(21) Appl. No.: 14/913,857

(22) PCT Filed: Aug. 20, 2014
(86) PCT No.: PCT/US14/51772

§ 371 Date: Feb. 23, 2016

Related U.S. Application Data
(60) Provisional application No. 61/869,291, filed on Aug. 23, 2013.

(51) Int. Cl. F21V 8/00; H05B 33/08; B32B 17/10

(52) U.S. Cl. CPC G02B 6/0051; B32B 17/10761; B32B 17/10788; B32B 17/10752; B32B 17/10743; B32B 17/10137; B32B 17/10541; B32B 17/10064; G02B 6/0031; H05B 33/0845; G02B 6/0093; B32B 2307/422; B32B 2307/412

(57) ABSTRACT

A lighting fixture having a glass structure having a first sheet of fusion drawn, chemically strengthened glass, a clear sheet element, a diffusing element having a first surface and a second surface, and a light source situated along one or more edges of the clear sheet element to thereby direct light into the clear sheet element. Another lighting fixture having an acrylic sheet with dispersive particles embedded therein that transfer light perpendicular to an axis of injection of the dispersive particles, the acrylic sheet having a first surface and a second surface. This lighting fixture also includes a first sheet of fusion drawn, chemically strengthened glass positioned on the first surface and a light source situated along one or more edges of the acrylic sheet to thereby direct light into the clear sheet element.

This application claims the benefit of priority to U.S. Provisional Application 61/869291 filed Aug. 23, 2013, the content of which is incorporated herein by reference in its entirety.

### BACKGROUND

Conventional ceiling light fixtures employ traditional fluorescent lights and high voltage fluorescent lighting fixtures as the lighting system to illuminate a predetermined area. These configurations pose several problems. For example, these configurations generally do not provide a uniform distribution of light, namely, black spots are present near the edges of the fixtures due to a lack of illumination at the ballasts of the conventional lighting fixtures. Furthermore, fluorescent lights do not produce a continuous steady output of light due to fluctuations in the frequency of the driving voltage. Additionally, some find the conventional fluorescent light color displeasing.

Thus, light emitting diodes (LEDs) have become more popular and prevalent, and it has become desirable to replace conventional lighting fixtures, ceiling or otherwise, with LED lighting units. Conventional LED lighting units, however, suffer from thick, heavy, and less than clear (optically yellow-green) glass elements. Therefore, there is a need to provide an improved LED lighting unit, lighting fixture or light panel.

### SUMMARY

The present disclosure generally relates to interior architectural elements and the design and manufacture of light-weight, fusion drawn glass and/or chemically strengthened fusion drawn glass LED lighting fixtures. Due to the superior strength and optical clarity of embodiments of the present disclosure, diffuser elements in conventional LED lighting fixtures can be eliminated.

Some embodiments provide an edge-lit LED lighting fixture or construction having one or more sheets of chemically strengthened glass (e.g., Gorilla® Glass), or an LED lighting fixture having a laminate structure with one or more sheets of chemically strengthened glass. Additional embodiments provide an LED lighting fixture having clear and/or super-clear interlayer products for optimal illumination and true color representation or an LED lighting fixture having a laminate structure with one or more sheets of chemically strengthened glass along with a thin white poly vinyl butyral (PVB) interlayer to provide superior light diffusion performance and to allow for the elimination of a separate plastic light diffusing sheet. Further embodiments provide an LED lighting fixture having improved strength lighted panels for walls and ceilings or an LED lighting fixture having low weight. Additional embodiments provide an LED lighting fixture having one or more chemically strengthened glass sheets with an acrylic light diffusing panel construction that is low weight and resists scratches, damage, and chemical cleaners. Other embodiments of the present disclosure include a transparent-to-opaque privacy glass product and applications therefor based on LED edge-lit technology.

One embodiment of the present disclosure provides a lighting fixture having a glass structure having a first sheet of fusion drawn, chemically strengthened glass. The lighting fixture also includes a clear sheet element, a diffusing element having a first surface and a second surface, and a light source situated along one or more edges of the clear sheet element to thereby direct light into the clear sheet element.

Another embodiment of the present disclosure provides a lighting fixture having an acrylic sheet with dispersive particles embedded therein that transfer light perpendicular to an axis of injection of the dispersive particles, the acrylic sheet having a first surface and a second surface. The lighting fixture also includes a first sheet of fusion drawn, chemically strengthened glass positioned on the first surface and a light source situated along one or more edges of the acrylic sheet to thereby direct light into the clear sheet element.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIGS. 1A and 1B are cross sectional illustrations of exemplary light emitting diode edge light panel embodiments.

FIGS. 2A and 2B are cross sectional illustrations of additional exemplary light emitting diode edge light panel embodiments.

FIG. 3 is a plot illustrating the load to initiate radial cracking for chemically strengthened glasses.

FIGS. 4 and 5 are plots illustrating optical clarity of embodiments of the present disclosure.

FIGS. 6A and AB are cross sectional illustrations of further exemplary light emitting diode edge light panel embodiments.

FIG. 7 is a simplified illustration of another embodiment of the present disclosure.

### DETAILED DESCRIPTION

With reference to the figures, where like elements have been given like numerical designations to facilitate an understanding of the present disclosure, the various embodiments for light emitting diode light panels are described.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those of ordinary skill in the art will recognize that many modifications and adaptations of the present disclosure are possible and can even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

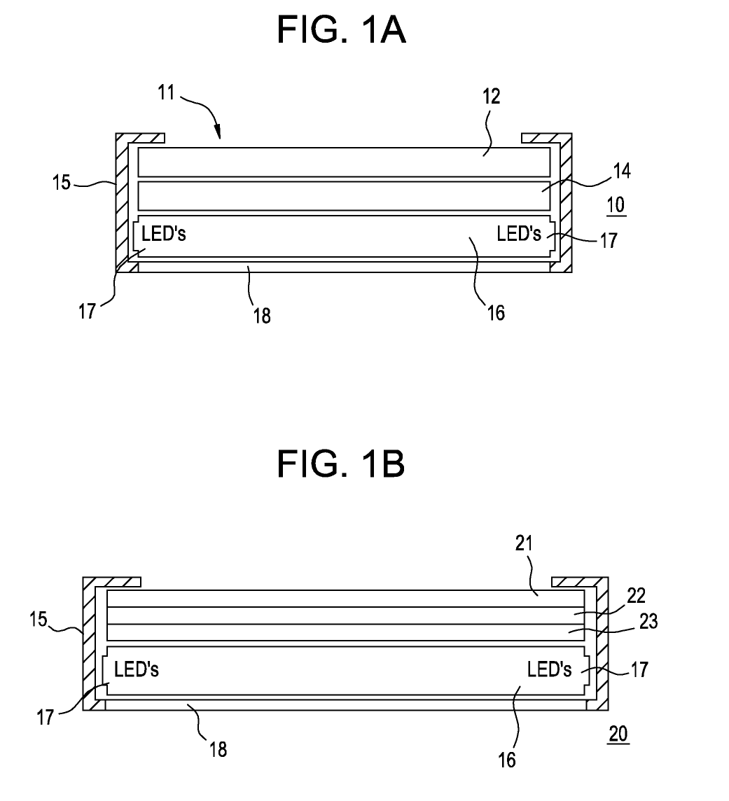

Figures 1A and 1B are cross sectional illustrations of exemplary light emitting diode edge light panel embodiments. With reference to FIG. 1A, one exemplary light emitting diode (LED) edge light panel 10 embodiment includes a layer of glass 12 (e.g., float glass, tempered glass, heat annealed glass, chemically-strengthened glass, etc.) forming a front face 11 of the panel 10 and overlying a light diffuser panel 14 or element. It should be noted that the terms “fixture”, “structure”, “panel”, and “unit” are used interchangeably in this disclosure and such use should not limit the scope of the claims appended herewith. An exemplary glass layer 12 can also be modified (e.g., tempered, etc.) to comply with safety glazing requirements, e.g., ANSI Z97.1, and the like. The diffuser panel 14 can include one or more exemplary diffuser elements, e.g., separate sheets, layers, or surface texturing of the glass layer 12 and/or a clear sheet element 16. The diffuser panel 14 can be a separate element below the glass layer 12 or can be incorporated on the front face 11 of the panel 10. Adjacent the light diffuser panel 14 is the clear sheet element 16 (e.g., acrylic, polycarbonate, etc.) whereby LEDs 17 can direct light therein from one or more edges of the clear sheet element 16. Light from the LEDs can also be reflected to the front face 11 by a back reflector element 18. With reference to FIG. 1B, another exemplary LED edge light panel 20 embodiment includes a layer of glass 22 (e.g., float glass, tempered glass, heat annealed glass, chemically-strengthened glass, etc.) intermediate two diffuser films 21, 23. The first diffuser film or layer 21 can be provided on the front surface of the glass layer 22, and the second diffuser film or layer 23 can be provided on the rear surface of the glass layer 22. Of course, this exemplary diffuser element(s) can also be formed by surface texturing of the glass layer 22 and/or a clear sheet element 16 or can be a combination of layers, films and texturing. Adjacent the second diffuser film or layer 23 is the clear sheet element 16 (e.g., acrylic, polycarbonate, etc.) whereby LEDs 17 can direct light therein from one or more edges of the clear sheet element 16. Light from the LEDs can also be reflected by a back reflector element 18.

With continued reference to FIGS. 1A-1B, exemplary diffuser elements 14, 21, 23 can be protected by a front clear layer, e.g., glass or a polymer, and can also include a single glass sheet or a glass lamination. These diffuser elements can be free standing (held by end bezels or other suitable frames 15) inside the light panel 10, 20 or can also be connected to the panel 10, 20 by lamination. Exemplary diffuser elements can be a combination of a separate panel (e.g., polycarbonate sheet constructed of small spherical bubbles), an applied film (e.g., sheet film), a painted film, a deposited layer, or a modified surface texture such as obtained via rough abrasion, polishing or differential etching Additional diffuser elements can be frosted, white or colored with a visible light transmittance (e.g., less than 30%, typically 5 to 15%). Colored or tinted diffuser elements can also be provided by a colored interlayer and/or a front or back diffuser element in the case of FIG. 1B. It should be noted that the thinner the utilized diffuser element, the thinner the resulting LED light panel 10, 20. In some embodiments, factors that determine how the glass layer 12, 22 is constructed or mounted can be a function of compliance with building codes or standards. Such exemplary LED light panels can provide an ambient white or tinted light that extends uniformly across the front face of the panel 10, 20 by incorporating one or more diffuser elements.

Other exemplary embodiments according to the present disclosure provide edge-lit lighting panels having a bright uniform and diffuse light source for architectural applications such as, but not limited to, ceiling and overhead lighting or for illuminated walls and surfaces. In some embodiments, a series of LEDs can be placed along perimeter edges of an exemplary panel or construction whereby light can be transmitted inward, across, and through the panel or construction toward an area where illumination is desired. Alternative embodiments can also employ Full-Array lighting whereby plural rows of LEDs can be placed behind the entire surface of a panel or construction.

In some embodiments, uniformity of the light emitted by LED light panels can be a major consideration whereby a waveguide or light pipe function can be employed to transmit light from edge-lit LEDs toward the center of the respective panel. In some embodiments, polymeric materials, e.g., acrylic, can be employed for this purpose. Once light is uniformly distributed across the panel, it can be diffused and directed through the panel into an area to be illuminated. Polycarbonate is also another exemplary, non-limiting material that can be employed for its light diffusing properties as a uniformly thick sheet or with three-dimensional features molded therein to provide light diffusion or to achieve a desirable aesthetic appearance. Engineered acrylic materials can also be employed that combine waveguide properties with light diffusing properties. Such exemplary multi-functional polymeric materials can thus be employed in embodiments of the present disclosure to avoid the need for other components in an exemplary light panel. As depicted in FIGS. 1A-1B, diffused light can be transmitted in all directions including the direction opposite to the area to be illuminated, and diffused light can also be re-directed toward the intended area through the use of a reflective material or reflector located on the backside of the light panel. Additional embodiments can include light intensity control mechanisms to deliver dimmable light and provide a large palette of color. Exemplary light panels can also address both optical as well as mechanical concerns, e.g., panel size, weight of the product, and environmental considerations such as human contact, weathering and fire. Exemplary applications for embodiments of the present disclosure include, but are not limited to, ceiling or vertical light panels for rooms and offices (ambient and designer lighting projects), lighted signage applications (internal and external graphic displays), light boxes for artists, draftsmen, and physicians (e.g., tracing of diagrams and drawings, X-ray film), lighted marking boards (workforce conference rooms, design rooms for note taking, advertising), and back lighting LCD applications (utilized for TV and consumer appliances). Exemplary applications can also utilize a glass laminate or a single glass sheet held or laminated to a diffuser element and can also include anti-splinter film, anti-microbial film, anti-glare film and other suitable films to meet specific building codes or to meet specific interior design requirements.

Exemplary glass sheets utilized in embodiments of the present disclosure can be formed from chemically-strengthened glass, thermal tempered glass, heat strengthened glass, annealed glass, soda lime glass, and glass ceramics, just to name a few. Additionally, embodiments of the present disclosure can employ exemplary polymeric materials in the place of glass sheets. Exemplary polymeric materials include, but are not limited to, plastics, polyvinyl butryal (PVB), ethylene vinyl acetate (EVA), SentryGlass® or other ionomers, polycarbonates, acrylics, and the like.

In additional embodiments of the present disclosure, thin chemically strengthened glass, e.g., Gorilla® Glass, can be employed to provide a light-weight solution to architectural requirements while providing benefits of durability and scratch and damage resistant surfaces to a respective light panel. Applicant has discovered that by replacing conventionally employed glass products with thin, chemically-strengthened glass, the weight of the respective device or panel can be reduced by at least 50% without compromising the safety or impact performance of the device or panel. Additionally, by employing such light-weight and thin glass elements, touch functionality and wireless communication functionality can be employed in embodiments of the present disclosure.

Suitable glass sheets used in embodiments of the present disclosure, whether in a single glass sheet embodiment or in a multi-layer glass sheet embodiment and used as an external and/or internal glass sheet, can be strengthened or chemically-strengthened by a pre- or post-ion exchange process. In this process, typically by immersion of the glass sheet into a molten salt bath for a predetermined period of time, ions at or near the surface of the glass sheet are exchanged for larger metal ions from the salt bath. In one embodiment, the temperature of the molten salt bath is about 430° C. and the predetermined time period is about eight hours. The incorporation of the larger ions into the glass strengthens the sheet by creating a compressive stress in a near surface region. A corresponding tensile stress is induced within a central region of the glass to balance the compressive stress.

Exemplary ion-exchangeable glasses that are suitable for forming glass sheets or glass laminates can be alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size. One exemplary glass composition comprises SiO₂, B₂O₃ and Na₂O, where (SiO₂+B₂O₃)≧66 mol. %, and Na₂O≧9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂;7-15 mol. % Al₂O₃; 0-12 mol. % B₂O₃; 9-21 mol. % Na₂O;0-4 mol. % K₂O; 0-7 mol. % MgO; and 0-3 mol. % CaO.

A further exemplary glass composition suitable for forming hybrid glass laminates comprises: 60-70 mol. % SiO₂; 6-14 mol. % Al₂O₃; 0-15 mol. % B₂O_{3;}0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. % (Li₂O+Na₂O+K₂O)≦20 mol. % and 0 mol. % ≦(MgO+CaO)≦10 mol. %. A still further exemplary glass composition comprises: 63.5-66.5 mol. % SiO₂;8-12 mol. % Al₂O₃;0-3 mol. % B₂O_{3;}0-5 mol. % Li₂O; 8-18 mol. % Na₂O; 0-5 mol. % K₂O; 1-7 mol. % MgO; 0-2.5 mol. % CaO;0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. % (Li₂O+Na₂O+K₂O)≦18 mol. % and 2 mol. % (MgO+CaO)≦7 mol. %.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{Σ modifiers} > 1 ,$$

where in the ratio the components are expressed in mol.% and the modifiers are alkali metal oxides. This glass, in particular embodiments, comprises, consists essentially of, or consists of: 58-72 mol. % SiO_{2;} 9-17 mol. % Al₂O_{3;} 2-12 mol. % B₂O_{3;} 8-16 mol. % Na₂O; and 0-4 mol. % K₂O, wherein the ratio

$$\frac{{Al}_{2} {O}_{3} + {B}_{2} {O}_{3}}{Σ modifiers} > 1.$$

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO. In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol.% Na₂O; 0-10 mol. % K₂O; 0-8 mol. % MgO; 0-10 mol. % CaO; 0-5 mol. % ZrO₂; 0-1 mol.% SnO₂;0-1 mol. % CeO₂; less than 50 ppm As₂O₃; and less than 50 ppm Sb₂O₃; wherein 12 mol. % Li₂O+Na₂O+K₂O 20 mol. % and 0 mol. % MgO+CaO≦10 mol. %. In still another embodiment, an alkali aluminosilicate glass comprises, consists essentially of, or consists of: 64-68 mol. % SiO₂;12-16 mol. % Na₂O; 8-12 mol. % Al₂O₃; 0-3 mol.% B₂O₃; 2-5 mol. % K₂O; 4-6 mol. % MgO; and 0-5 mol. % CaO, wherein: 66 mol. % SiO₂+B₂O₃+CaO≦69 mol. %; Na₂O+K₂O+B₂O₃+MgO+CaO+SrO>10 mol. %; 5 mol.% MgO+CaO+SrO≦8 mol. %; (Na₂O+B₂O₃)-Al₂O₃≦2 mol. %; 2 mol. % Na₂O -Al₂O₃≦6 mol. %; and 4 mol. % ≦(Na₂O+K₂O)- Al₂O₃≦10 mol. %.

Exemplary chemically-strengthened as well as non-chemically-strengthened glass, in some embodiments, can be batched with 0-2 mol. % of at least one fining agent selected from a group that includes Na₂SO₄, NaC1, NaF, NaBr, K₂SO₄, KC1, KF, KBr, and SnO₂. In one exemplary embodiment, sodium ions in exemplary chemically-strengthened glass can be replaced by potassium ions from the molten bath, though other alkali metal ions having a larger atomic radii, such as rubidium or cesium, can replace smaller alkali metal ions in the glass. According to particular embodiments, smaller alkali metal ions in the glass can be replaced by Ag⁺ions. Similarly, other alkali metal salts such as, but not limited to, sulfates, halides, and the like may be used in the ion exchange process. The replacement of smaller ions by larger ions at a temperature below that at which the glass network can relax produces a distribution of ions across the surface of the glass that results in a stress profile. The larger volume of the incoming ion produces a compressive stress (CS) on the surface and tension (central tension, or CT) in the center of the glass. The compressive stress is related to the central tension by the following relationship:

$$CS = CT ( \frac{t - 2 DOL}{DOL} )$$

where t represents the total thickness of the glass sheet and DOL is the depth of exchange, also referred to as depth of layer.

According to various embodiments, glass sheets and/or glass laminate structures comprising ion-exchanged glass can possess an array of desired properties, including low weight, high impact resistance, and improved sound attenuation. In one embodiment, a chemically-strengthened glass sheet can have a surface compressive stress of at least 250 MPa, e.g., at least 250, 300, 400, 450, 500, 550, 600, 650, 700, 750 or 800 MPa, a depth of layer at least about 20 μm (e.g., at least about 20, 25, 30, 35, 40, 45, or 50 μm) and/or a central tension greater than 40 MPa (e.g., greater than 40, 45, or 50 MPa) but less than 100 MPa (e.g., less than 100, 95, 90, 85, 80, 75, 70, 65, 60, or 55 MPa). A modulus of elasticity of a chemically-strengthened glass sheet can range from about 60 GPa to 85 GPa (e.g., 60, 65, 70, 75, 80 or 85 GPa). The modulus of elasticity of the glass sheet(s) and the polymer interlayer can affect both the mechanical properties (e.g., deflection and strength) and the acoustic performance (e.g., transmission loss) of the resulting glass laminate.

Exemplary glass sheet forming methods include fusion draw and slot draw processes, which are each examples of a down-draw process, as well as float processes. These methods can be used to form both chemically-strengthened and non-chemically-strengthened glass sheets. The fusion draw process generally uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, because the two glass films flowing over the channel fuse together, neither outside surface of the resulting glass sheet comes in contact with any part of the apparatus. Thus, the surface properties of the fusion drawn glass sheet are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet and into an annealing region. The slot draw process can provide a thinner sheet than the fusion draw process because a single sheet is drawn through the slot, rather than two sheets being fused together.

Down-draw processes produce glass sheets having a uniform thickness that possess surfaces that are relatively pristine. Because the strength of the glass surface is controlled by the amount and size of surface flaws, a pristine surface that has had minimal contact has a higher initial strength. When this high strength glass is then chemically strengthened, the resultant strength can be higher than that of a surface that has been a lapped and polished. Down-drawn glass may be drawn to a thickness of less than about 2 mm. In addition, down drawn glass has a very flat, smooth surface that can be used in its final application without costly grinding and polishing

In the float glass method, a sheet of glass that may be characterized by smooth surfaces and uniform thickness is made by floating molten glass on a bed of molten metal, typically tin. In an exemplary process, molten glass that is fed onto the surface of the molten tin bed forms a floating ribbon. As the glass ribbon flows along the tin bath, the temperature is gradually decreased until a solid glass sheet can be lifted from the tin onto rollers. Once off the bath, the glass sheet can be cooled further and annealed to reduce internal stress.

As noted above, exemplary glass sheets can be used to form glass laminates or glass laminate structures. The term “thin” as used herein means a thickness of up to about 2.0 mm, up to about 1.5 mm, up to about 1.0 mm, up to about 0.7 mm, or in a range of from about 0.5 mm to about 2.0 mm, from about 0.5 to about 1.5 mm, from about 0.5 to about 1.0 mm, or from about 0.5 mm to about 0.7 mm. The terms “sheet”, “structure”, “glass structures”, “laminate structures” and “glass laminate structures” may be used interchangeably in the present disclosure and such use should not limit the scope of the claims appended herewith. As defined herein, a glass laminate can also comprise an externally or internally-facing chemically-strengthened glass sheet, an internally or externally facing non-chemically-strengthened glass sheet, and a polymer interlayer formed between the glass sheets. The polymer interlayer can comprise a monolithic polymer sheet, a multilayer polymer sheet, or a composite polymer sheet. The polymer interlayer can be, for example, a plasticized poly(vinyl butyral) sheet.

Conventional glass to glass laminations utilize glass sheets thicker than 3 mm in their constructions due to the difficulty of manufacturing and strengthening of thinner glass sheets. The clarity of these laminations are not optimized for a white light application due to the green-yellow color obtained from soda-lime glass constructions or even iron-free soda-lime glass constructions. Additionally, these conventional constructions are too thick and heavy for LED light panels that are to be suspended horizontally or vertically. Exemplary embodiments of the present disclosure provide front glass elements constructed with fusion drawn compositions, such as Gorilla® Glass, either as single layers or as multi-layer laminations. These embodiments are thinner than conventional standard float glass products, provide thinner and stronger front glass elements in lighting panels than conventional glass elements resulting in new lighter-weight LED panel constructions, provide pristine and optically clear glass, and provide glass laminate solutions having a wide variety of color options when color is required to be directed (light panel applications) or observed (signage light panel applications). Exemplary embodiments of the present disclosure providing front glass elements constructed with fusion drawn compositions, such as, Gorilla® Glass either as single layers or as multi-layer laminations also provide a simplified LED panel construction when the diffuser element is incorporated into the fusion drawn glass front glass element. Further embodiments can employ acrylic or other materials (e.g., ACRYLITE®) to provide waveguide and light diffusing optical properties and can reduce the use or eliminate the need for a diffuser element in an LED light panel design.

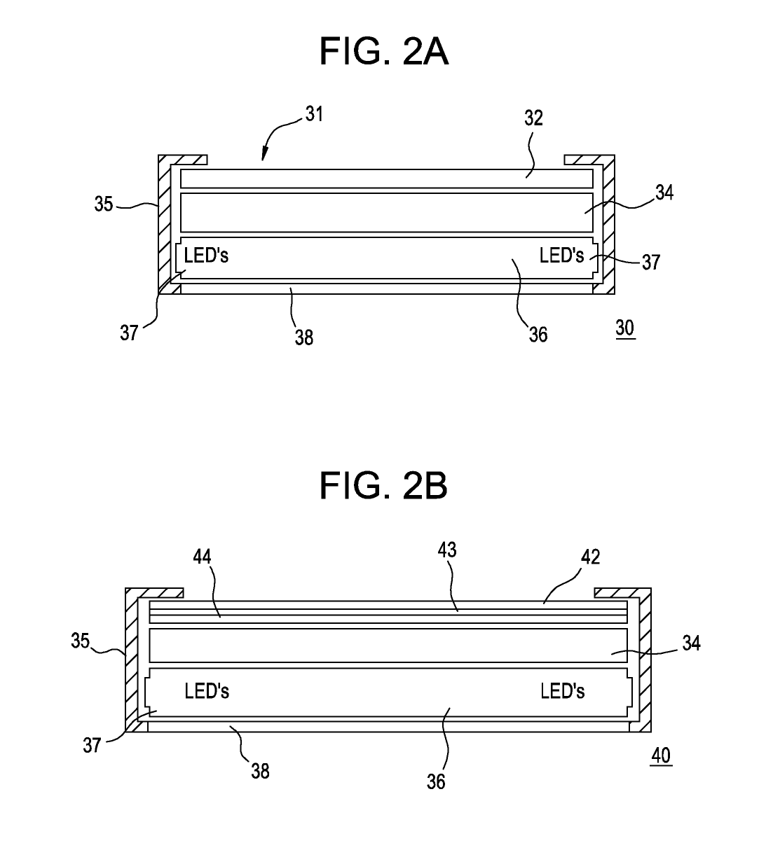

FIGS. 2A and 2B are cross sectional illustrations of additional exemplary light emitting diode edge light panel embodiments. With reference to FIG. 2A, one exemplary LED edge light panel 30 embodiment includes a layer of fusion drawn glass 32 (e.g., Gorilla® Glass) forming a front face 31 of the panel 30 and overlying a light diffuser panel 34 or element. An exemplary glass layer 32 can also be modified (e.g., etched, etc.) to comply with safety glazing requirements. The diffuser panel 34 can include one or more exemplary diffuser elements, e.g., separate sheets, layers, or surface texturing of the glass layer 32 and/or a clear sheet element 36. The diffuser panel 34 can be a separate element below the glass layer 32 or can be incorporated on the front face 31 of the panel 30. Adjacent the light diffuser panel 34 is the clear sheet element 36 (e.g., acrylic, polycarbonate, etc.) whereby LEDs 37 can direct light therein from one or more edges of the clear sheet element 36. Light from the LEDs can also be reflected to the front face 31 by a back reflector element 38. With reference to FIG. 2B, another exemplary LED edge light panel 40 embodiment includes a first layer of fusion drawn glass 42 (e.g., Gorilla® Glass) and a second layer of fusion drawn glass 44 having an intermediate interlayer 43. Of course, any one or both of the first or second layers 42, 44 can be other types of glass (e.g., float glass, tempered glass, heat annealed glass, chemically-strengthened glass, etc.). The panel 40 can also include a diffuser element 34 which can be formed by a separate sheet, film or can be a surface texturing of the glass layer(s) or a clear sheet element 36 or can be a combination thereof. Adjacent the diffuser element 34 is the clear sheet element 36 (e.g., acrylic, polycarbonate, etc.) whereby LEDs 37 can direct light therein from one or more edges of the clear sheet element 36. Light from the LEDs can also be reflected by a back reflector element 38. Thus, a front glass element or layer can be a single sheet of fusion drawn glass or a lamination of two or more sheets and an interlayer(s). These exemplary constructions can be freely mounted (held by an end bezel or other suitable frame 35) or adhered to an underlying LED light panel construction. Exemplary adhesives include, but are not limited to, optically clear adhesives or laminations.

With continued reference to FIG. 2B, an exemplary optically clear interlayer includes, but is not limited to, Solutia RA41, DuPont SG-NUV, and the like, to highlight the clarity of exemplary fusion drawn glass, to display images, and to provide optically clear and/or colored light solutions. In some embodiments, the use of a thin white interlayer, e.g., Solutia Polar White RB17, having a thickness of less than about 0.38 mm with a visible light transmittance typically around 5 to 15%, can be employed as an exemplary diffuser element. A thicker white interlayer can be employed by adding an additional 0.38 mm clear interlayer (e.g., Solutia RA11, or RB11) to increase the total interlayer thickness and to provide a tinting of the light as it escapes the interlayer. Embodiments incorporating this white interlayer can allow the removal of a diffuser element. As noted above, glass laminations finding utility in building applications are subjected to building codes that require materials to pass boil, impact, weathering, and/or fire standards. Fusion drawn glass elements, e.g., Gorilla® Glass, pass these tests and also provide additional advantages such as, but not limited to, increased strength over current soda-lime glass/lamination constructions, increased optical clarity (e.g., non-green) over current soda-lime glass/lamination constructions, an enabling of low profile LED packages due to the thinness of Gorilla® Glass, increased scratch & wear resistance, increased chemical resistance, increased UV light resistance, reduced weight, increased strength and resistance to damage and breakage, increased flexibility to resist breakage, and true color display with no parallax distortion.

Exemplary glass panels employing fusion drawn glasses, e.g., Gorilla® Glass, can be utilized in thicknesses of less than about 2 mm. Preferable thicknesses for single layer constructions can be greater than about 0.3 mm and can be less than about 1.0 mm. In some embodiments, thicknesses for laminations having Gorilla® Glass can be between about 0.5 mm to less than about 3 mm (i.e., the total front glass element thickness). Of course, additional fusion drawn compositions, such as, but not limited to Eagle XG, Willow glass, and the like, can be utilized in embodiments of the present disclosure and can have thicknesses varying from greater than about 10 microns to less than about 1 mm. Table 1 provided below provides summaries of strength comparisons between conventional heat strengthened glass and fusion drawn chemically strengthened glass, e.g., Gorilla® Glass.

TABLE 1

| Type of Glass | |
|---|---|
| Strengthening | Strength Comparison |
| Ion exchange (chemically | Fusion drawn glass is approximately 6 to 8x |
| tempered) | the strength of annealed glass. Surface |
| | compression is 50,000 to 100,000 psi |
| | (690 MPa) |
| Thermally tempered glass | Approximately 4x the strength of annealed |
| (fully tempered) | glass. Surface compression is greater than |
| | 10,000 (69 MPa) to 20,000 psi. |
| Heat strengthened glass | Approximately 2x the strength of annealed |
| | glass. Surface compression is 6,000 to 9,000 |
| | psi. |

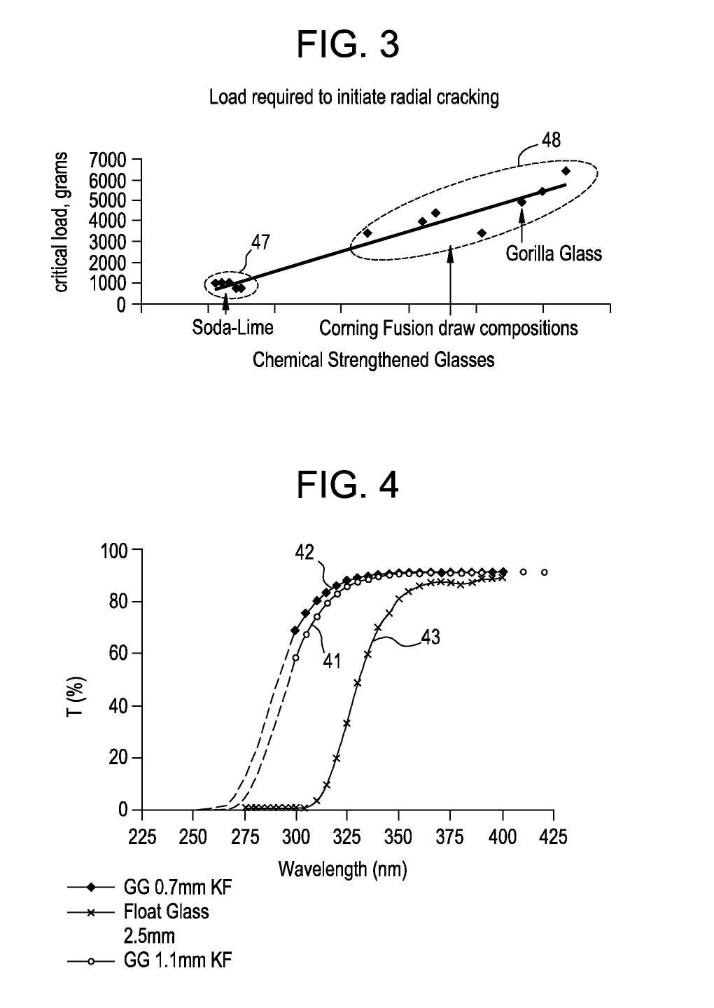

FIG. 3 is a plot illustrating the load to initiate radial cracking for chemically strengthened glasses. With reference to FIG. 3, a strength comparison between chemically strengthened soda-lime glass 47 and various Corning fusion drawn compositions 48 is illustrated. It can be observed that the larger glass rupture resistance of Corning fusion drawn compositions 48 results in a reduction in optically observed surface scratches. Weight reduction from embodiments of the present disclosure, as compared to conventional glass constructions, can be deduced by assuming no significant glass density deviations are present. Such weight reductions (also assuming that similar interlayers are utilized in laminations) can then be simple ratios of the respective glass thickness. For example, for single Gorilla® Glass sheets the weight reduction typically ranges from 3× to 5× as compared to standard 3 mm soda-lime glass sheets. When utilizing very thin fusion drawn Corning compositions, such as Willow glass, Eagle XG, etc., a 30× weight reductions can be observed when compared to 3 mm soda-lime glass sheets.

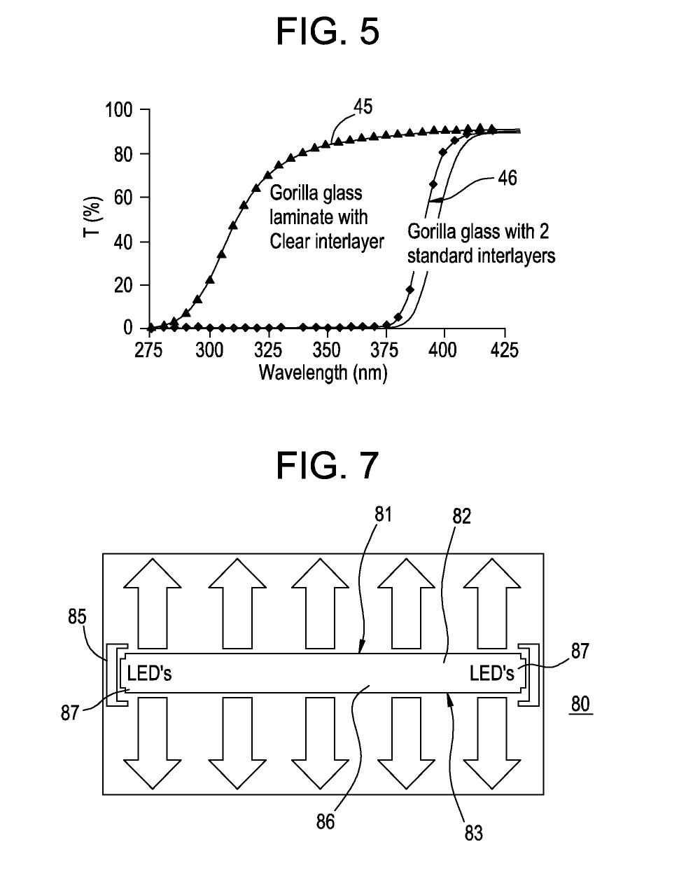

FIGS. 4 and 5 are plots illustrating optical clarity of embodiments of the present disclosure. With reference to FIG. 4, the clarity of a 1.1 mm thick Gorilla® Glass sheet 41, a 0.7 mm thick Gorilla® Glass sheet 42, and a 2.5 mm thick soda lime glass sheet 43 are compared. As illustrated, the total transmission of light demonstrates that the clarity of Gorilla® Glass is superior to low iron soda lime glass (typically providing a green tint) and, with the combination of optically clear interlayers, can result in ultra-clear laminations. Colored interlayers or images behind exemplary front fusion drawn glass element(s) (single sheet or laminated) can, however, be utilized to display true colors (i.e., color uncompromised by any coloring present in standard present-day front glass element constructions). With reference to FIG. 5, the clarity of an embodiment of the present disclosure having a clear interlayer providing a near-perfect clear lamination with no color 45 is compared with embodiments having two standard interlayers 46. It should be noted that for the spectra for Gorilla® Glass-containing embodiments, the transmission level flat-lines to 900 nm indicating that no color results from the longer wavelengths and only the shorter wavelengths produce the lightest of tints which are difficult to visually detect with a bright white backing. It should also be noted that the clarity of Gorilla® Glass having two standard interlayers was found to be far superior to conventional soda lime glass thus providing near-clear solutions.

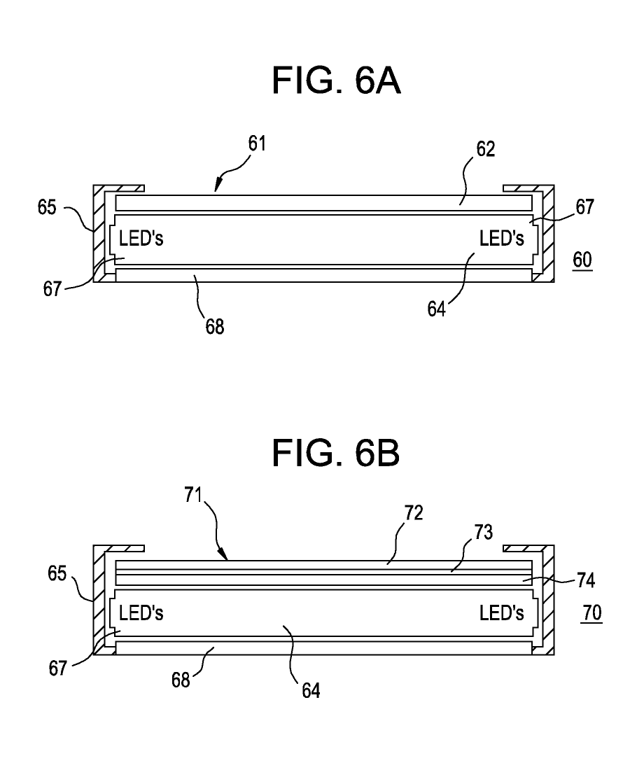

FIGS. 6A and AB are cross sectional illustrations of further exemplary light emitting diode edge light panel embodiments. With reference to FIG. 6A, one exemplary LED edge light panel 60 embodiment includes a layer of fusion drawn glass 62 (e.g., Gorilla® Glass) forming a front face 61 of the panel 60 and overlying a clear sheet having an acrylic material 64 whereby LEDs 67 can direct light therein from one or more edges of the acrylic material 64. An exemplary glass layer 62 can also be modified (e.g., etched, etc.) to comply with safety glazing requirements. In the illustrated embodiment, rather than providing a separate diffuser element, a diffuser can be incorporated either as a single sub-element, e.g., film, deposited film, painted layer, surface texture, or colored/white laminate interlayer with a visible light transmittance less than about 50%, typically 5 to 15% or as a combination of diffuser sub-elements. Light from the LEDs 67 can also be reflected to the front face 61 by a back reflector element 68. With reference to FIG. 6B, another exemplary LED edge light panel 70 embodiment includes a first layer of fusion drawn glass 72 (e.g., Gorilla® Glass) and a second layer of fusion drawn glass 74 having an intermediate interlayer 73. Of course, any one or both of the first or second layers 72, 74 can be other types of glass (e.g., float glass, tempered glass, heat annealed glass, chemically-strengthened glass, etc.). These exemplary constructions can be freely mounted (i.e., to a bezel or other suitable frame 65) or adhered to an underlying LED light panel construction. Exemplary adhesives include, but are not limited to, optically clear adhesives or laminations. The laminate structure 72, 73, 74 overlies a clear sheet having an acrylic material 64 whereby LEDs 67 can direct light therein from one or more edges of the acrylic material 64. Any one of the exemplary glass layers 72, 74 can also be modified (e.g., etched, etc.) to comply with safety glazing requirements. In the illustrated embodiment, rather than providing a separate diffuser element, a diffuser can be incorporated either as a single sub-element, e.g., film, deposited film, painted layer, surface texture, or colored/white laminate interlayer with a visible light transmittance less than about 50%, typically 5 to 15% or as a combination of diffuser sub-elements. Light from the LEDs can also be reflected to the front face 71 by a back reflector element 68.

FIG. 7 is a simplified illustration of another embodiment of the present disclosure. With reference to FIG. 7, an exemplary LED edge light panel 80 embodiment includes a layer of fusion drawn glass 82 (e.g., Gorilla® Glass) forming a front face 81 of the panel 80 and overlying a clear sheet having an acrylic material 84 whereby LEDs 87 can direct light therein from one or more edges of the acrylic material 84. Adjacent the acrylic material 84 and on an opposing surface thereof is a second layer of fusion drawn glass 86 (e.g., Gorilla® Glass) forming a rear face 83 of the panel 80. Any one or both of the glass layers 82, 86 can also be modified (e.g., etched, etc.) to comply with safety glazing requirements. In the illustrated embodiment, rather than providing a separate diffuser element, a diffuser can be incorporated either as a single sub-element, the acrylic material 84. These exemplary constructions can be freely mounted (i.e., to a bezel or other suitable frame 85) or adhered to an intermediate LED light panel construction. Exemplary adhesives include, but are not limited to, optically clear adhesives or laminations. In one embodiment, the acrylic material can include dispersive particles embedded therein that transfer light perpendicular to the axis of injection (e.g., ACRYLITE®). Thus, edge lighting on an exemplary acrylic material can transmit light to both front and rear faces 81, 83 of the panel 80. While the illustrated embodiment depicts the use of a single Gorilla® Glass layer on both sides of the acrylic material 84, the claims appended herewith should not be so limited as embodiments can utilize a laminate structure (see, e.g., FIGS. 2B and 6B) including Gorilla® Glass on one or both sides of the acrylic material 84. In experiments of such embodiments, no optical concerns in light uniformity were observed with the use of such acrylic materials in replacing an acrylic sheet element and diffuser element. Advantages of such embodiments include, but are not limited to, a separate diffuser element is no longer critical for uniform dispersion of the light, two edges only require illumination, a uniform graded illumination can be achieved with a single edge of LEDs, two substantially identical light paths in opposing directions can be generated, clear and/or tinted interlayers can be employed in embodiments to achieve higher light transmission, a rigid thin profile LED uniform light panel with minimal elements can be produced, and a clear solution for an LED light panel product can be achieved. In additional embodiments, LED strips or individual LEDs can be positioned around the perimeter of an exemplary panel or at other locations in or on the panel to use the glass or laminate structure as a waveguide, dispersing light such that the glass panel glows.

Utilizing an LED light panel embodiment depicted in FIG. 7 can also provide a clear LED light panel solution when the LED lights are off and an opaque appearance when the lights are on, e.g., a switchable transparent to opaque privacy glass. In such embodiments, the degree of opaqueness can be a function of the intensity of the respective LED light source(s). Utilizing an exemplary dimming circuit, an exemplary panel's appearance can transition from essentially 100% transparent to 100% opaque, progressing through intermediate levels of transparency, or the transition can be instantaneous with an on/off control. Applications for such an embodiment include, but are not limited to, privacy glass, decorative lighting, and safety lighting. Further applications include clear stairways, clear walls, or clear marker boards could become opaque when needed, e.g., motion detection or on-demand under the control of a user. LED lighted information boards utilizing such embodiments can also be clear, displaying images when in the “off” mode but can become opaque when switched in the “on” mode thereby making the images disappear.

As noted above, in some of the embodiments described herein, the intensity of emitted light can be controlled by several mechanisms such as, but not limited to, dimmers, manual variable controls, voice, motion or heat activated controls (or other automated, computer controlled, manually controlled mechanisms) to reduce heat produced by radiant energy. To reduce or eliminate lighting “hot spots” (areas where people perceive the light source) and to create a uniform lighting, the glass or laminate material can be etched to create a diffuse surface. For example, opal glass can be employed to produce uniform lighting for microscopy or photography or holography. Other means of creating uniform lighting through the use of holographic diffusers, chemical etchants, sand or bead blasting glass can also be employed in embodiments of the present disclosure. Exemplary diffusion profiles can range from narrow line to a broad Lambertian profile to homogenize non-uniform light emitted from many sources, including LEDs. Thus, in some embodiments the glass or glass laminate panel can also include a variety of materials selected for their unique properties in creating a light-weight, strong, visually appealing and user interactive panel.

One embodiment of the present disclosure provides a lighting fixture having a glass structure having a first sheet of fusion drawn, chemically strengthened glass. In some embodiments, the glass structure further comprises a second sheet of glass and an interlayer intermediate the first sheet of fusion drawn, chemically strengthened glass and the second sheet of glass. In other embodiments, the second sheet of glass can be, but is not limited to, a sheet of fusion drawn, chemically strengthened glass, a sheet of float glass, a sheet of tempered glass, a sheet of soda lime glass, and a sheet of heat annealed glass. Exemplary interlayers can be polyvinyl butryal (PVB), ethylene vinyl acetate (EVA), an ionomer, a polycarbonate, an acrylic, and a polymeric material. The lighting fixture also includes a clear sheet element, a diffusing element having a first surface and a second surface, and a light source situated along one or more edges of the clear sheet element to thereby direct light into the clear sheet element. In some embodiments, the lighting fixture includes a reflector overlying a surface of the clear sheet element opposite the diffusing element. A frame can be provided to hold the glass structure, diffusing element, clear sheet element, and light source in a predetermined space. Exemplary light sources can be, but are not limited to, an LED, an array of LEDs, and the like. Further embodiments can include a clear, white or tinted interlayer intermediate the first glass sheet and diffusing element. Of course, the lighting fixture can be any suitable lighting fixture, e.g., a horizontal or vertical lighting fixture. An exemplary clear sheet element can comprise an acrylic, polycarbonate, glass or glass-ceramic material. Exemplary thicknesses of the first sheet (and second sheet) of fusion drawn, chemically strengthened glass can be between about 0.5 mm to about 2.0 mm, between about 0.5 to about 1.5 mm, between about 0.5 to about 1.0 mm, or between about 0.5 mm to about 0.7 mm. Exemplary thicknesses of the glass structure can be between about 0.3 mm and about 3 mm or between about 0.5 mm and 1.0 mm.

A further embodiment of the present disclosure provides a lighting fixture having an acrylic sheet having dispersive particles embedded therein that transfer light perpendicular to an axis of injection of the dispersive particles, the acrylic sheet having a first surface and a second surface. The lighting fixture also includes a first sheet of fusion drawn, chemically strengthened glass positioned on the first surface and a light source situated along one or more edges of the acrylic sheet to thereby direct light into the clear sheet element. Another embodiment of the lighting fixture can include a second sheet of glass positioned on the second surface of the acrylic sheet. In other embodiments, the second sheet of glass can be, but is not limited to, a sheet of fusion drawn, chemically strengthened glass, a sheet of float glass, a sheet of tempered glass, a sheet of soda lime glass, and a sheet of heat annealed glass. In some embodiments, the lighting fixture can include a second sheet of glass and an interlayer intermediate the first sheet of fusion drawn, chemically strengthened glass and the second sheet of glass. As noted above, this second sheet of glass can be, but is not limited to, a sheet of fusion drawn, chemically strengthened glass, a sheet of float glass, a sheet of tempered glass, a sheet of soda lime glass, and a sheet of heat annealed glass. Exemplary interlayers can be polyvinyl butryal (PVB), ethylene vinyl acetate (EVA), an ionomer, a polycarbonate, an acrylic, and a polymeric material. A frame can be provided to hold the acrylic sheet, first sheet of fusion drawn, chemically strengthened glass, and light source in a predetermined space. Exemplary light sources can be, but are not limited to, an LED, an array of LEDs, and the like. Further embodiments can include a clear, white or tinted interlayer intermediate the first glass sheet and diffusing element. Of course, the lighting fixture can be any suitable lighting fixture, e.g., a horizontal or vertical lighting fixture. Exemplary thicknesses of the first sheet (and second sheet) of fusion drawn, chemically strengthened glass can be between about 0.5 mm to about 2.0 mm, between about 0.5 to about 1.5 mm, between about 0.5 to about 1.0 mm, or between about 0.5 mm to about 0.7 mm. Exemplary thicknesses of the glass structure can be between about 0.3 mm and about 3 mm or between about 0.5 mm and 1.0 mm. In some embodiments, the lighting fixture includes a reflector overlying a surface of the acrylic sheet opposite the first sheet of fusion drawn chemically strengthened glass.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-7, various embodiments for light emitting diode light panels have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

1. A lighting fixture comprising:
a glass structure having a first sheet of chemically strengthened glass;
a clear sheet element;
a diffusing element having a first surface and a second surface; and
a light source situated along one or more edges of the clear sheet element to thereby direct light into the clear sheet element.

2. The lighting fixture of claim 1 wherein the glass structure further comprises a second sheet of glass and an interlayer intermediate the first sheet of chemically strengthened glass and the second sheet of glass.

3. The lighting fixture of claim 2 wherein the second sheet of glass is selected from the group consisting of a sheet of chemically strengthened glass, a sheet of float glass, a sheet of tempered glass, a sheet of soda lime glass, and a sheet of heat annealed glass.

4. The lighting fixture of claim 2 where the interlayer is formed from a material selected from the group consisting of polyvinyl butryal (PVB), ethylene vinyl acetate (EVA), an ionomer, a polycarbonate, an acrylic, and a polymeric material.

5. The lighting fixture of claim 1 further comprising a reflector overlying a surface of the clear sheet element opposite the diffusing element.

6. The lighting fixture of claim 1 further comprising a frame holding the glass structure, diffusing element, clear sheet element, and light source in a predetermined space.

7. The lighting fixture of claim 1 wherein the light source is a light emitting diode (LED) or an array of LEDs.

8. The lighting fixture of claim 1 further comprising a clear, white or tinted interlayer intermediate the first glass sheet and diffusing element.

9. (canceled)

10. The lighting fixture of claim 1 wherein the clear sheet element is formed from an acrylic, polycarbonate, glass or glass-ceramic material.

11. The lighting fixture of claim 1 wherein the thickness of the first sheet of chemically strengthened glass is between about 0.5 mm to about 2.0 mm, between about 0.5 to about 1.5 mm, between about 0.5 to about 1.0 mm, or between about 0.5 mm to about 0.7 mm

12. The lighting fixture of claim 1 wherein the thickness of the glass structure is between about 0.3 mm and about 3 mm or between about 0.5 mm and 1.0 mm.

13. A lighting fixture comprising:
an acrylic sheet having dispersive particles embedded therein that transfer light perpendicular to an axis of injection of the dispersive particles, the acrylic sheet having a first surface and a second surface;
a first sheet of fusion drawn, chemically strengthened glass positioned on the first surface; and
a light source situated along one or more edges of the acrylic sheet to thereby direct light into the acrylic sheet.

14. The lighting fixture of claim 13 further comprising a frame holding the acrylic sheet, first sheet of fusion drawn, chemically strengthened glass, and light source in a predetermined space.

15. The lighting fixture of claim 13 further comprising a second sheet of glass positioned on the second surface of the acrylic sheet.

16. The lighting fixture of claim 15 wherein the second sheet of glass is selected from the group consisting of a sheet of fusion drawn, chemically strengthened glass, a sheet of float glass, a sheet of tempered glass, a sheet of soda lime glass, and a sheet of heat annealed glass.

17. The lighting fixture of claim 13 further comprising a second sheet of glass and an interlayer intermediate the first sheet of fusion drawn, chemically strengthened glass and the second sheet of glass.

18. The lighting fixture of claim 17 wherein the second sheet of glass is selected from the group consisting of a sheet of fusion drawn, chemically strengthened glass, a sheet of float glass, a sheet of tempered glass, a sheet of soda lime glass, and a sheet of heat annealed glass.

19. (canceled)

20. The lighting fixture of claim 18 wherein the light source is a light emitting diode (LED) or an array of LEDs.

21. The lighting fixture of claim 13 wherein the thickness of the first sheet of fusion drawn, chemically strengthened glass is between about 0.5 mm to about 2.0 mm, between about 0.5 to about 1.5 mm, between about 0.5 to about 1.0 mm, or between about 0.5 mm to about 0.7 mm.

22. The lighting fixture of claim 13 further comprising a reflector overlying a surface of the acrylic sheet opposite first sheet of fusion drawn chemically strengthened glass.

23. (canceled)
